(19) United States
(12) Patent Application Publication
(10) Pub. No.: US 2013/0113192 A1
(43) Pub. Date: May 9, 2013

(54) Inflatable Curtain Airbag With Twist Indicator

(71) Applicants: Charles Richards, Farmington, UT (US); Abe Mitchel, Brigham City, UT (US); David J. Orton, Ogden, UT (US); Allen Chambers, Syracuse, UT (US)

(72) Inventors: Charles Richards, Farmington, UT (US); Abe Mitchel, Brigham City, UT (US); David J. Orton, Ogden, UT (US); Allen Chambers, Syracuse, UT (US)

(21) Appl. No.: 13/291,428

(22) Filed: Nov. 8, 2011

(51) Int. Cl. B60R 21/16

(52) U.S. Cl. 280/730.2

(57) ABSTRACT

An inflatable curtain airbag includes a luminescent visual marking indicating a proper installation of a compacted airbag bundle. Luminescent materials, when exposed to electromagnetic radiation of one frequency range, emit electromagnetic radiation in a different frequency range. This emitted radiation can be automatically detected by an optical detection device. The simplest marking consists of a line extending along the length of the airbag bundle. To facilitate recognition of the marking in an automated quality control, the marking may consist of a number of parallel lines, a portion of which may be broken lines, or a row of dots lined up along the length of the bundle. When the curtain airbag is compacted to a bundle, the marking may be located anywhere on the surface of the bundle in an area facing the interior of the vehicle.

### FIELD OF THE INVENTION

The present invention relates to an inflatable curtain airbag assembly with an aid to verify proper installation in a vehicle.

### BACKGROUND OF THE INVENTION

Inflatable safety restraint devices, or airbags, are well accepted for use in motor vehicles and have been credited with preventing numerous deaths and injuries. Inflatable airbags are now mandatory on most new vehicles. Airbags are typically installed as part of a system with an airbag module in the steering wheel on the driver's side of a car and in the instrument panel on the passenger side of a car. In the event of an accident, a sensor within the vehicle measures abnormal deceleration and triggers the ignition of an explosive charge contained within an inflator. Expanding gases from the charge travel through conduits and fill the airbags, which immediately inflate in front of the driver and passenger to protect them from harmful impact with the interior of the car.

Side impact airbag systems have also been developed in response to the need for similar protection from lateral impacts between a passenger and the side of a vehicle's interior. This might occur when another vehicle collides with the side of the car, or in a rollover situation where the side of the car is repeatedly impacting the ground. One form of these airbags, provided for the protection of the head and upper torso of an occupant and commonly referred to as “inflatable curtains,” may be mounted on or near the roof rail, or a portion of a vehicle frame that extends along a length of the vehicle between the side windows and the roof.

An inflatable curtain airbag is typically compacted by folding, rolling, or a combination of both rolling and folding, to create a tube-shaped bundle for stowing the cushion behind a headliner covering the interior of the roof of the vehicle. The curtain airbag is typically designed to unroll or unfold downward from the roof of the vehicle during inflation and becomes positioned on the outboard side of the occupant. Generally, the inflatable curtain airbag is sized to descend below the window sill. Consequently, when not inflated, the curtain airbag includes a significant amount of material. This material is then rolled, folded, or otherwise gathered to form a tight, tubular bundle, which must be packed into a small packaging space. A wrapper may be added to ensure that the curtain airbag is kept rolled or folded.

The compacted curtain airbag is then mounted either on or close to a roof rail of the vehicle. A metal gas guide that extends from the inflator is then connected to an inlet port of the inflatable curtain.

Once the curtain airbag has been rolled or folded into the bundle, it is important that the curtain airbag is installed properly. The soft, pliable material of the airbag makes it possible that it is installed in an improper, twisted manner that may remain unnoticed. Installing the curtain airbag in a twisted configuration, however, may be detrimental to the proper function the curtain airbag.

In an attempt to reduce the likelihood that the inflatable curtain will be installed in a twisted manner, it has been proposed to provide alignment lines or other similar markings that give a visual guide to a person installing, inspecting, or servicing the airbag, thus helping to avoid or retroactively detect a twisted installation of a curtain airbag. Manually detecting a twisted or entangled installation of the airbag, however, requires additional time and labor and thus adds to the costs of installing curtain airbags.

It has also been suggested to provide a stiffening member built into the curtain airbag along its length that prevents twisting and retains the shape of the curtain airbag bundle. Such a stiffening member, however, adds to the bulk and weight of the airbag module. Also, the stiffening member complicates the installation of the curtain airbag because the thus reinforced bundle has a significant length that cannot be reduced by folding it due to its stiffness.

### SUMMARY OF THE INVENTION

Accordingly, a need exists for an inflatable curtain airbag assembly that provides an easy and low-cost solution to ensure a proper installation and detection of a twisted installation, particularly during installation or automated quality control. It is particularly desirable to reduce labor costs while consistently ensuring proper installation.

The present invention meets this need by providing an inflatable curtain assembly that includes a luminescent visual marking that may be fluorescent or phosphorescent and that indicates a proper installation. Luminescent materials, when exposed to electromagnetic radiation of one frequency range, emit electromagnetic radiation in a defined frequency range, either at the same time (fluorescence) or for a duration extending beyond the time at which the electromagnetic energy is absorbed (phosphorescence). The emitted radiation can be automatically detected by an optical detection device. Such detection devices use sensors that are inexpensive and reliable. The emitted radiation of the marking may be in the visible light spectrum to make it detectable to the human eye and to an automatic optical detector alike. The luminescent material may absorb electromagnetic radiation in the UV spectrum, for instance so-called black light.

The simplest marking consists of a line extending along the length of the airbag bundle. Such a line can be manufactured by weaving a luminescent thread into the airbag material. The thread has been dyed with a luminescent dye before weaving. The marking may also be applied to an assembled curtain airbag by painting or printing so that the unprocessed airbag fabric itself does not need a marking specific to an individual type of airbag. To facilitate recognition of the marking in an automated quality control, the marking may consist of a number of parallel lines, a portion of which may be broken lines, or a row of dots lined up along the length of the bundle. When the curtain airbag is compacted to a bundle, the marking may be located anywhere on the surface of the bundle in an area facing the interior of the vehicle or in an area accessible to an optical inspection after installation.

In one configuration according to this invention, the inflatable curtain airbag is rolled into a bundle. For such a bundle, the surface of the bundle is formed by portion of the curtain airbag that is proximate to fastening structures for mounting the curtain airbag on one side of the curtain airbag. The marking can be applied before compacting the curtain airbag because the surface of the bundle facing the vehicle interior is known before compacting.

In another configuration according to the invention, the inflatable curtain airbag is folded into a bundle. The surface of the folded bundle is formed by narrow stripes of airbag fabric. Variances in folding the airbag may make it harder to determine in advance which portions of the airbag fabric will be forming the surface of the bundle after compacting. In such a case, the marking may be applied with luminescent paint or ink after folding the curtain airbag to a bundle.

Further details and advantages become apparent from the following description of exemplary embodiments illustrated in the attached drawings. The drawings are included for illustrative purposes only and are not to be considered to limit the scope of the invention.

### BRIEF DESCRIPTION OF THE DRAWINGS

In the drawings,

FIG. 1 is a plan view of one embodiment of an inflatable curtain airbag in an unfolded state;

FIG. 2 shows the curtain airbag of FIG. 1 rolled up in a bundle properly installed in a motor vehicle;

FIG. 3 shows the curtain airbag of FIG. 1 rolled up in a bundle improperly installed in a motor vehicle;

FIG. 4 shows a sectional view through the curtain airbag of FIGS. 1-3; and

FIG. 5 shows sectional view through an alternative embodiment of a compacted curtain airbag of the present invention.

### DETAILED DESCRIPTION OF THE DRAWINGS

In FIG. 1, a curtain airbag 1 according to at least one embodiment is shown in a non-inflated and unfolded state. At its upper section 2, the curtain airbag 1 exhibits a number of retaining means in the form of mounting tabs 4, which are used for fixing of the curtain airbag 1 in the side roof frame area of a motor vehicle. Furthermore, curtain airbag 1 exhibits an inflatable protection area 27 which is linked with a gas generator 25 by means of its filling channel 26. Gas generator 25 is connected with airbag 1, for example, in the front area of the upper section 2 and may also be connected with a sensor and evaluation unit, so that it is activated if a side or rollover accident is sensed and thereby inflates curtain airbag 1. Gas generator 25 in this case conducts the gas directly into the filling channel 26, which guides the gas into the respective chambers. Alternatively, the gas generator 25 can be connected with a filling tube or filling pipe which is inserted into filling channel 26. This allows both the airbag fabric and the seams to be protected from the hot gas streaming out of the gas generator.

The inflatable protection area 27 is divided into a number of chambers 5, 6, 7, 8, and 9 which are divided from one another by darts or stitchings 10, 11, 12, and 13. Chambers 5, 6, 7, 8, and 9 are arranged in such a way that a front section of the protection area is formed for the front seats of a motor vehicle by means of chambers 7, 8, and 9 and a rear section of the protection area is formed for the rear seats of a motor vehicle by chambers 5 and 6. Between the front section and the rear section a non-inflatable section 14 is formed in an area which no vehicle occupant can typically reach during the accident. This can be in the area of a vehicle B pillar, for example.

Two guide chambers 15 and 16 are provided in the upper section 2 of curtain airbag 1, which are connected in one piece with the protection area and which project over upper section 2. They are connected from the point of view of gas flow with filling channel 26 of curtain airbag 1, so that the gas which is created by gas generator 25 can enter quickly into guide chambers 15 and 16. Guide chambers 15 and 16 may be each located between two mounting links 4 whereby front guide chamber 15 is allocated to the B pillar area of the vehicle and rear guide chamber 16 is allocated to a C pillar area of the vehicle when in a mounted state.

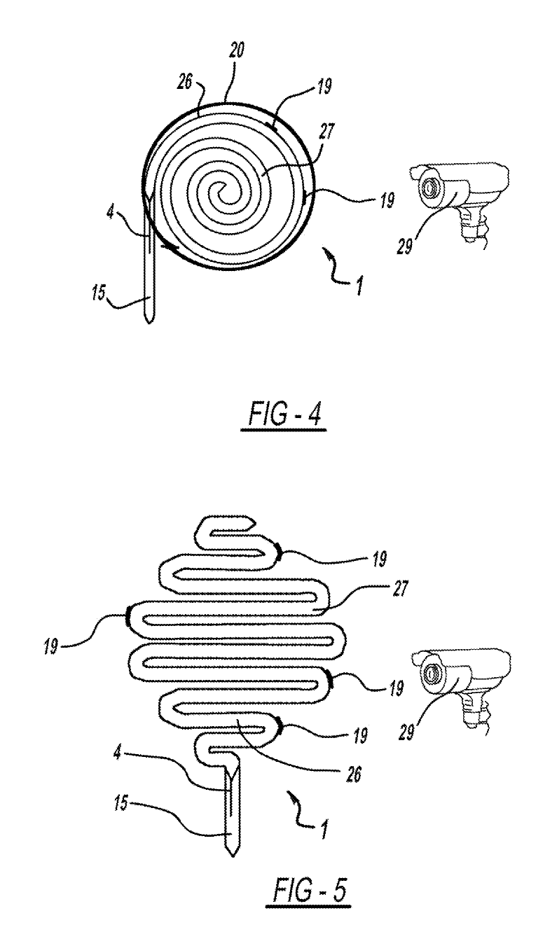

A horizontal marking 19 extends along the entire length of the airbag 1 near the mounting tabs 4. The marking 19 consists of a luminescent material that is produced by weaving a luminescent thread into the airbag fabric. The luminescence may be due to a fluorescent or a phosphorescent property of the thread. But the marking 19 may also be painted or drawn with a stroking utensil like a paintbrush or a marker, or printed or stamped onto the fabric of the airbag 1 by contact with a utensil transferring a printing line or pattern. The material of the marking 19 emits electromagnetic radiation in a frequency that is distinguishable by an automated optical detection device 29 (as indicated in FIG. 4) from the color of the airbag fabric. The marking 19, shown in the drawing as a textured line, may have other distinguishing features in its appearance, such as constituting an array of parallel lines or dots lined up like a string of beads, or any other shape that gives it a unique appearance enhancing optical machine detection. While the marking 19 is shown to extend along the entire length of the airbag 1, it may only be applied in areas between two adjacent tabs 4 or in areas where a twisted installation of the airbag 1 would otherwise be hard to detect. The location of the marking 19 is shown for illustrative purposes only. As will become evident below, the marking 19 may be located at any distance from the tabs 4 that is visible after compacting the airbag 1 and fixed to a vehicle.

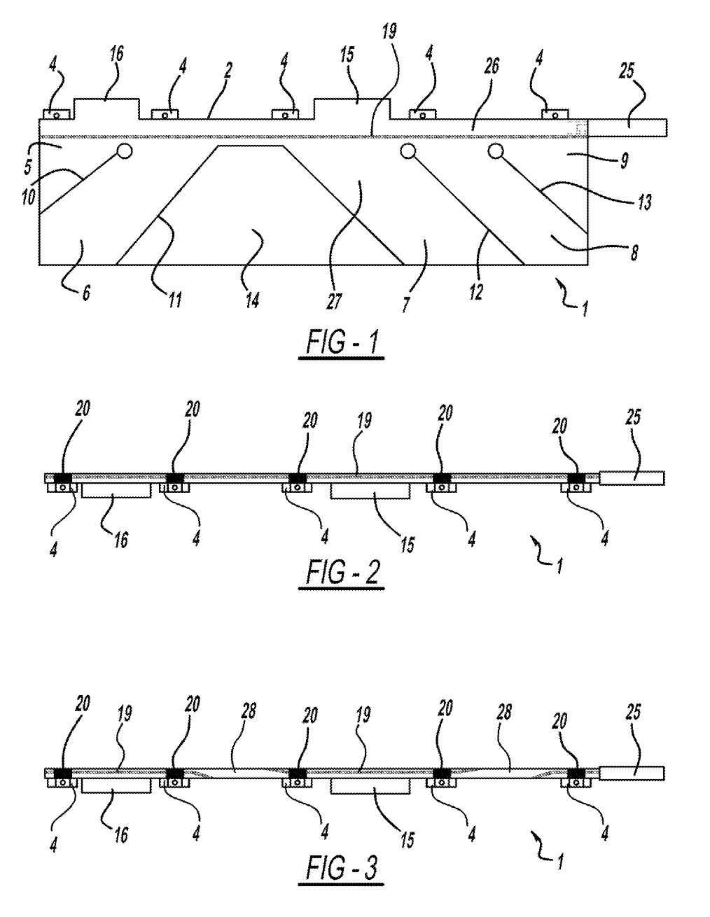

FIG. 2 illustrates the embodiment of the curtain airbag 1 of FIG. 1 in its compacted state, which may be folded or rolled. The orientation of the airbag 1 corresponds to the mounted position in the roof frame area of the vehicle. Mounting links 4 project away from rolled curtain airbag 1 and point downwards. Thus, the fixing points by means of which curtain airbag 1 is fixed to the roof may be located underneath the folded roll.

A plurality of retaining straps 20 extending like a cover around the rolled curtain airbag 1 may be assigned to the mounting links 4, which hold the airbag in its rolled state. The retaining straps 20 may be configured to tear when the curtain airbag 1 is inflated. A perforation can be provided for this purpose, or the material thickness can be correspondingly thinner. As an alternative to straps 20, a single wrapper can be provided which corresponds to the length of curtain airbag 1. If a continuous wrapper is used, the marking 19 may be applied to the wrapper, or the wrapper may be translucent so as to allow the optical detection device 29 to detect the marking 19 through the wrapper.

In FIG. 2, the airbag has been properly installed in a vehicle without twisting. The proper installation is evident from the continuously visible marking 19 that is only interrupted by the retaining straps 20. The automatic optical detection device 29 can be programmed to memorize the locations of the retaining straps 20 in order to account for interruptions in the detection of the marking 19 caused by the retaining straps. Accordingly, during an automated quality inspection, the optical detection device 29 detects the continuous course of the marking 19 across the entire length of the marking and confirms proper installation of the airbag 1.

In contrast to FIG. 2, FIG. 3 shows the airbag 1 of FIG. 1 after a twisted installation in a vehicle. Notably, the marking 19 does not form a continuously visible line or string, but leaves voids 28 between adjacent retaining straps 20. The optical detection device 29, programmed to account for interruptions in the marking 19 that correspond to the retaining straps 20, recognizes that the voids 28 are gaps in the marking 19 that are due to improper installation. Accordingly, the optical detection device 29 gives an alert indicating that the airbag 1 is twisted.

FIG. 4 illustrates a section through a compacted airbag 1. In the embodiment of FIG. 4, the airbag 1 is rolled up and tied together with straps 20. The compacted curtain airbag 1 shown in cross section may exhibit a letter “p”-shaped form. Mounting tab 4 is located in front of guide chamber 15, which is pointing downwards. The inflatable protection area 27 is folded together as a roll. It can be seen that curtain airbag 1 is attached to the vehicle with its tabs 4 so that the markings 19 face toward the inside of the vehicle. Accordingly, at least one of the markings 19 is arranged on a surface that is exposed after mounting the airbag in a vehicle so that the optical detection device 29 is able to verify a proper installation. An optional light source 30, such as a black light, may illuminate the bundle to activate the luminescent activity of the markings 19. The depiction of the optical detection device 29 and the light source 30 serves for symbolic purposes only and is not meant to specify any appearance or shape of the optical detection device 29 and light source 30 used to implement the present invention.

In FIG. 4, the marking 19 is applied twice to illustrate possible locations of the marking 19. Only one marking 19 is required for the present invention, but the invention is not limited to only one marking 19. On a symmetric airbag 1 that is rolled up from the bottom in opposing directions for mounting on opposite sides of the vehicle, two markings 19 may be applied on opposing outer surfaces of the airbag 1 so that one of the markings is detectable by the optical detection device 29, possibly supported by the light source 30, regardless of the direction in which the airbag 1 is rolled up for compacting.

Now referring to FIG. 5, a compacted airbag 1 is shown that has been folded into a bundle for mounting in a vehicle. Not shown are straps 20 or a wrapper applied to retain the compacted shape of the airbag 1. As is evident from the markings 19, the locations of the markings 19 are not limited to the proximity of the tabs 4, but may be arranged in any place where the airbag surface faces outward. In the embodiment shown, the airbag 1 may be mounted on the left side of the figure or the right side. If the airbag 1 is mounted on the left side, the markings 19 applied on the right side remain visible for an optical inspection by an optical detection device. If the airbag 1 is mounted on the right side, the marking 19 on the left side is accessible for an optical inspection by the optical detection device 29. The indicated locations of the markings are shown for exemplary purposes only. One marking applied in a location exposed to the outside of the bundle and thus accessible for inspection after fixing the airbag 1 in a vehicle is sufficient. For added flexibility in the choice of a mounting position of the airbag 1, several marking 19 may be applied.

If folding the airbag 1 involves variances in locations of creases, the marking 19 may be applied to the compacted airbag 1 after folding. That way, it is ensured that the marking 19 is located on the outside of the folded airbag 1 where it is accessible for inspection. The marking 19 may be sprayed on, stamped, or applied with a marker pen or applied by any other method that is suitable for reliably transferring luminescent paint, ink, or dye onto the airbag material.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. An airbag assembly, comprising:
an inflatable curtain in a compacted state having a gas inlet for receiving an inflation gas and at least one mounting device for mounting the inflatable curtain in a vehicle along a length of the inflatable curtain; and
at least one luminescent marking extending along the length of the inflatable curtain in a location accessible to an optical detection device after mounting the airbag in the vehicle, the marking being detectable by the optical detection device, the marking displaying a proper shape upon a proper installation in the vehicle and an improper shape upon a twisted installation in the vehicle.

2. The airbag assembly of claim 1, comprising two of the markings extending on two opposing surfaces of the curtain, of which at least one is accessible to the optical detection device on the curtain in the compacted state.

3. The airbag assembly of claim 1, wherein the at least one marking is applied to the curtain prior to compacting the curtain into a bundle.

4. The airbag assembly of claim 1, wherein the at least one marking is applied to the curtain after compacting the curtain into a bundle.

5. The airbag assembly of claim 1, further comprising a wrapper surrounding the compacted curtain, the wrapper bearing the at least one marking.

6. The airbag assembly of claim 1, wherein the at least one marking includes an array of parallel lines.

7. The airbag assembly of claim 1, wherein the at least one marking includes a luminescent pattern.

8. The airbag assembly of claim 1, wherein the at least one marking is printed.

9. The airbag assembly of claim 1, wherein the at least one marking is painted.

10. The assembly of claim 1, wherein the at least one marking consists of a phosphorescent material.

11. The assembly of claim 1, wherein the at least one marking consists of a fluorescent material.

12. The airbag assembly of claim 1, further comprising that the curtain in the compacted state is a rolled bundle with the at least one marking extending along the length of the rolled bundle on an outer layer.

13. The airbag assembly of claim 1, further comprising that the curtain in the compacted state is a folded bundle with the at least one marking extending along the length of the folded bundle on an outward-facing fold.

14. The airbag assembly of claim 1, wherein the marking in the proper shape comprises at least one continuous marking section that is interrupted in the improper shape.
